(19) United States
(12) Patent Application Publication
(10) Pub. No.: US 2010/0099026 A1
(43) Pub. Date: Apr. 22, 2010

(54) ELECTRODE INK COMPOSITION FOR INK-JET PRINTING, AND ELECTRODE AND SECONDARY BATTERY MANUFACTURED BY USING THE SAME

(75) Inventors: Jae-man Choi, Hwaseong-si (KR); Han-su Kim, Seoul (KR); Moon-seok Kwon, Hwaseong-si (KR); Un-gyu Paik, Seoul (KR); Jin-hyon Lee, Seoul (KR); Hyun-ho Kim, Seoul (KR); Sung-bok Wee, Seoul (KR)

Correspondence Address: STEIN MCEWEN, LLP, 1400 EYE STREET, NW, SUITE 300, WASHINGTON, DC, 20005, US

(73) Assignees: Samsung Electronics Co., Ltd., Suwon-si (KR); Industry-University Cooperation Foundation Hanyang University, Seoul (KR)

(21) Appl. No.: 12/578,868

(22) Filed: Oct. 14, 2009

(30) Foreign Application Priority Data
Oct. 20, 2008 (KR) 10-2008-0102466
Sep. 9, 2009 (KR) 10-2009-0085075

(51) Int. Cl. H01M 4/60; H01M 4/88; H01B 1/12; H01M 4/02

(52) U.S. Cl. 429/212; 252/182.1; 252/500; 429/209

(57) ABSTRACT

An electrode ink composition for ink-jet printing and an electrode and secondary battery manufactured by ink-jet printing the electrode ink composition. The electrode ink composition includes an electrode active material and a solvent. A fine electrode pattern is formed by ink-jet printing the electrode ink composition, and thus a thin micro secondary battery can be manufactured.

### CROSS-REFERENCE TO RELATED APPLICATION

This application claims the benefit of Korean Patent Application No. 10-2008-0102466, filed Oct. 20, 2008 and Korean Patent Application No. 10-2009-0085075, filed Sep. 9, 2009, in the Korean Intellectual Property Office, the disclosures of which are incorporated herein by reference.

### BACKGROUND OF THE INVENTION

1. Field of the Invention

One or more embodiments relate to an electrode ink composition for ink-jet printing, and an electrode and lithium battery manufactured by using the same, and more particularly, to an electrode ink composition for ink-jet printing, which is used to form a fine electrode pattern, and an electrode and lithium battery manufactured by ink-jet printing the electrode ink composition.

2. Description of the Related Art

Secondary batteries are becoming increasingly used as a power source for mobile electronic devices, such as mobile phones, personal digital assistants (PDAs), or portable multimedia players (PMPs); a power source for driving motors of high power hybrid mobile vehicles or electric vehicles; or a power source for flexible displays, such as electronic ink (e-ink), electronic paper (e-paper), or flexible liquid crystal display devices (LCDs, or flexible organic light emitting diodes (OLEDs). In the future, secondary batteries are expected to be used as a power source for integrated circuit devices on printed circuit boards.

However, when used as the power source for mobile electronic devices, secondary batteries need to be packaged for safety purposes and thus there is a limitation on the product design of secondary batteries. In addition, to be used as the power source for driving motors, secondary batteries need to supply high power, and be small and lightweight. Also, to be used as the power source for flexible displays, secondary batteries need to be thin, lightweight, and flexible. Further, to be used as a power source for integrated circuit devices, secondary batteries need to be patterned accurately.

As a method of manufacturing an electrode to satisfy various needs for secondary batteries described above, ink-jet printing can be used instead of conventional slurry coating. When ink-jet printing is used to manufacture an electrode for secondary batteries, a thin, uniform, and flat electrode can be manufactured and a desired electrode pattern can be formed at low cost.

Meanwhile, a secondary battery electrode forming composition principally includes a lithium-transition metal oxide that functions as an electrode active material, a solvent that is used as a medium, and a binder that binds an electrode and particles together after the solvent is removed. The solvent may include at least one solvent selected according to dispersibility of particles and ejection and drying characteristics of the secondary battery electrode forming composition. Conventionally, N-methyl-2-pyrrolidone (NMP) is used as a main solvent. NMP has high solubility with respect to poly(vinylidene fluoride)(PVdF) that is conventionally used as a binder. However, NMP has a high boiling point and low volatility, and thus a relatively low drying rate.

### SUMMARY OF THE INVENTION

One or more embodiments include an electrode ink composition that is used to manufacture an electrode having a fine or precise pattern formed by ink-jet printing. One or more embodiments include an electrode and secondary battery manufactured by ink-jet printing the electrode ink composition. Additional aspects will be set forth in part in the description which follows and, in part, will be apparent from the description, or may be learned by practice of the invention.

To achieve the above and/or other aspects, one or more embodiments may include an electrode ink composition for ink-jet printing, including an electrode active material and a solvent, wherein the amount of the electrode active material is in a range of about 1 to about 20 weight % based on the total weight of the electrode ink composition; and the solvent includes a first solvent having a boiling point in a range of about 150 to about 170° C. at 1 atm, and a surface tension of 30 dyne/cm or more at 25° C.

The first solvent may be a solvent including an amide group. The solvent including the amide group may be selected from dimethyl acetamide, dimethyl formamide, or a mixture of these. The amount of the first solvent may be in a range of about 80 to about 100 weight % based on the total weight of the solvent. The electrode ink composition may further include at least one component selected from the group consisting of a binder, a conductive agent, a moisturizing agent, a dispersant, and a buffer.

To achieve the above and/or other aspects, one or more embodiments may include a secondary battery electrode manufactured by ink-jet printing the electrode ink composition described above. To achieve the above and/or other aspects, one or more embodiments may include a secondary battery including the secondary battery electrode described above.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a photographic image showing the result produced when an electrode ink composition prepared according to Example 1 is used to form an electrode by ink-jet printing; and

FIG. 2 is a photographic image showing the result produced when an electrode ink composition prepared according to Comparative Example 1 is used to form an electrode by ink-jet printing.

### DETAILED DESCRIPTION OF THE EMBODIMENTS

Reference will now be made in detail to embodiments of the present invention, examples of which are illustrated in the accompanying drawings. The embodiments are described below in order to explain the present invention by referring to the figures.

Hereinafter, according to one embodiment, an electrode ink composition for ink-jet printing will be described in detail. The electrode ink composition for ink-jet printing includes an electrode active material and a solvent. The amount of the electrode active material may be in a range of about 1 to about 20 weight % based on the electrode ink composition, and the solvent may include a first solvent that has a boiling point in the range of about 150 to about 170° C. at 1 atm and a surface tension of 30 dyne/cm or more at 25° C.

N-methyl-2-pyrrolidone (NMP) is conventionally used in a secondary battery electrode forming composition. However, the boiling point of NMP is relatively high and thus the drying rate is low. Accordingly, when an electrode is manufactured by ink-jet printing, wherein the electrode is formed from an electrode ink composition including NMP as a main solvent, un-dried droplets may move away from the target point due to high surface tension or may agglomerate together with other droplets, and thus fine or precise patterning may be difficult. Since the first solvent used in this embodiment has a relatively low boiling point, phenomena caused by un-dried droplets may be prevented and thus an electrode ink composition having a predetermined surface tension that is suitable for forming a fine or precise pattern can be prepared.

The first solvent used in the electrode ink composition according to this embodiment may have a surface tension in the range of about 30 to about 40 dyne/cm. When the surface tension is 30 dyne/cm or more, the contact angle between the ink and the nozzle surface during printing, the contact angle between the ink and the nozzle plate during printing, and the contact angle between the ink and the collector after printing are high. However, when the boiling point is also considered, the desired surface tension may be 40 dyne/cm or lower.

The first solvent may be an amide group-containing solvent. Although other solvents can be used, the amide group-containing solvent donates a non-covalent electron pair from the oxygen included in the carbonyl group to the metal moiety of the electrode active material included in the electrode ink composition, so that the surface energy of the electrode active material is lowered and electrode particles are thus well dispersed. For example, the first solvent may be selected from dimethyl acetamide (DMAC), dimethyl formamide (DMF), and mixtures of these.

For the electrode ink composition for ink-jet printing according to this embodiment, the first solvent may be mixed with a second solvent depending on the purpose of use. Examples of the second solvent include saturated hydrocarbons such as hexane; aromatic hydrocarbons such as toluene or xylene; alcohols such as methanol (MeOH), ethanol (EtOH), propanol (PrOH), or butanol (BuOH); ketones such as acetone, methyl ethyl ketone (MEK), methyl isobutyl ketone (MIBK), or diisobutyl ketone; esters such as ethyl acetate or butyl acetate; ethers such as tetrahydrofuran (THF), dioxane, or diethylether; dimethylsulfoxide (DMSO); and mixtures of these, but are not limited thereto. When the first solvent is mixed with the second solvent, the amount of the first solvent may be in a range of about 80 to about 100 weight % based on the combined weight of the first and second solvents.

For the electrode ink composition for ink-jet printing according to this embodiment, the electrode active material is not limited as long as the objectives of the electrode ink composition are maintained, and may be any oxide that is conventionally used as an electrode active material for a secondary battery. Examples of a suitable cathode active material include an Li—Co based complex oxide such as LiCoO₂, an Li—Ni based complex oxide such as LiNiO₂, an Li—Mn based complex oxide such as LiMn₂O₄ or LiMnO₂, an Li—Cr based complex oxide such as Li₂Cr₂O₇ or Li₂CrO₄, an Li—Fe based complex oxide such as LiFeO₂, and an Li—V based complex oxide. Examples of a suitable anode active material include an Li—Ti based complex oxide such as Li₄Ti₅O₁₂, a transition metal oxide such as SnO₂, In₂O₃, or Sb₂O₃, and carbon such as graphite, hard carbon, acetylene black, or carbon black.

The amount of the electrode active material may be in a range of about 1 to about 20 weight % based on the weight of the electrode ink composition but is not limited thereto. Specifically, the amount of the electrode active material may be in a range of about 3 to about 7 weight % based on the weight of the electrode ink composition. Within these ranges, the electrode ink composition has a moderate viscosity, and thus excellent stability and ejection properties can be maintained and printing efficiency may be increased.

The electrode ink composition has a viscosity of 100 mPa·sec or less, for example, 0.5 to 5 mPa·sec when measured at a temperature of 25° C. and a shear rate of 1000 s⁻¹. Measurements were made using an AR-2000 (TA Instruments) and also shown in Table 1.

According to another embodiment, the electrode ink composition may further include at least one of a binder, a conductive agent, a moisturizing agent, a dispersant, and a buffer. The binder may be used to provide a binding force to the electrode active material with respect to a polar plate so that the electrode active material binds to the polar plate after ink-jet printing. The binder may include one or two different materials selected from the group consisting of polyvinyl alcohol, an ethylene-propylene-diene terpolymer, styrene-butadiene rubber, poly(vinylidene fluoride) (PVdF), poly(tetrafluoroethylene) (PTFE), a tetrafluoroethylene-hexfluoropropylene copolymer, and carboxymethyl cellulose, but is not limited thereto. Specifically, the binder may be PVdF. The amount of the binder may be in a range of about 0.01 to about 10 weight %, specifically about 0.05 to about 5 weight %, based on the weight of the electrode ink composition, but is not limited thereto.

The conductive agent is used to improve conductivity of the electrode active material. Any conductive agent may be used as long as the objectives of the specific electrode ink composition are achieved. Examples of the conductive agent include acetylene black, carbon black, graphite, carbon fiber, and carbon nanotubes, but are not limited thereto. The amount of the conductive agent may be in a range of about 1 to about 20 weight % based on the electrode active material, but is not limited thereto.

The moisturizing agent is used to prevent the electrode ink composition from drying in a nozzle and thus to prevent nozzle clogging. Examples of the moisturizing agent include glycols, glycerols, and pyrrolidone, but are not limited thereto. The amount of the moisturizing agent may be in a range of about 5 to about 40 weight % based on the weight of the electrode ink composition. However, if the drying suppression effect of the electrode ink composition is sufficient because of the amount of the first solvent used, the moisturizing agent may be eliminated.

The dispersant is used to disperse the electrode active material and the conductive agent. Any dispersant may be used as long as the properties of the electrode ink composition are maintained. The dispersant may include one or two different compounds selected from a fatty acid salt, an alkyl dicarboxylic acid salt, an alkyl sulfuric acid ester salt, a polyvalent sulfuric acid ester alcohol salt, an alkylnaphthalene sulfuric acid salt, an alkylbenzene sulfuric acid salt, an alkylnaphthalene sulfuric acid ester salt, an alkylsulfone succinic acid salt, a naphthenic acid salt, an alkylether carboxylic acid salt, an acylated peptide, an alpha-olefin sulfuric acid salt, an N-acylmethyltaurine salt, an alkylether sulfuric acid salt, a secondary polyvalent alcohol ethoxy sulfate, a polyoxyethylene alkyl permylether sulfuric acid salt, monoglysulfate, an alkyl ether phosphoric acid ester salt, an alkyl phosphoric acid ester salt, an alkylamine salt, an alkylpyridium salt, an alkylimidazolium salt, a fluorine based- or silicon based-acrylic acid polymer, a polyoxyethylene alkyl ether, a polyoxyethylene sterol ether, lanolin derivatives of polyoxyethylene, a polyoxyethylene/polyoxypropylene copolymer, a polyoxyethylene sorbitan fatty acid ester, a monoglyceride fatty acid ester, a sucrose fatty acid ester, an alkanol amide fatty acid, a polyoxyethylene fatty acid amide, a polyoxyethylene alkyl amine, polyvinyl alcohol, polyvinylpyridone, a polyacrylamide, a carboxylic group-containing aqueous polyester, a hydroxyl group-containing cellulose based resin, an acryl resin, butadiene resin, acrylic acids, styrene acryls, polyesters, polyamides, polyurethanes, alkyl betamine, an alkyl amine oxide, and phosphatidylcholine.

The amount of the dispersant may be in a range about 1 to about 20 weight % based on the weight of the electrode active material. In some cases, however, the dispersant may be eliminated depending on the characteristics or dispersibility of a particular electrode.

In addition, the electrode ink composition for ink-jet printing according to this embodiment may further include a buffer to ensure stability and to control the pH of the electrode ink composition to be in an appropriate range. Examples of the buffer include one or two different compounds selected from amines such as trimethylamine, triethanolamine, or diethanolamine, sodium hydroxide, and ammonium hydroxide. The amount of the buffer may be in a range about 0.1 to about 5 weight % based on the weight of the electrode active material. In some cases, however, the buffer may be eliminated depending upon the properties of the electrode ink composition.

The electrode ink composition including these components described above is prepared in an ink form and used for ink-jet printing. In this regard, the components of the electrode ink composition, such as the electrode active material, the solvent, the binder, the moisturizing agent, the conductive agent, the dispersant, and the buffer, are mixed in appropriate amounts. The mixture of components is milled with a ball mill and then the ball-milled mixture is bead-milled. The mixture that has been ball-milled and bead-milled is then passed first through a 1 μm PTFE syringe filter and then a 0.45 μm PTFE syringe filter, thereby completing the manufacture of an electrode ink composition for ink-jet printing.

The obtained electrode ink composition for ink-jet printing is printed in a predetermined pattern on a collector by using, for example, an ink-jet printer, thereby forming an electrode. The ink-jet printing is performed by ejecting the electrode ink composition from the nozzle of an ink-jet printer onto a collector so that ink droplets are printed on the collector. The ink-jet printing may be performed using a thermally driven method or a method using piezoelectric elements. Specifically, use of the method using piezoelectric elements may be desirable in terms of thermal stability of the battery forming materials. If a cathode composition including a cathode active material is ink-jet printed, a cathode is manufactured, and if an anode composition including an anode active material is ink-jet printed, an anode is manufactured.

The electrode ink composition may be ink-jet printed in various ways. For example, an ink-jet printer including an ink-jet head may be connected to a commercially available computer and appropriate software is used to form a predetermined pattern on a collector. The electrode ink composition printed on the collector may be dried at a temperature in the range of about 20 to about 200° C. in a vacuum for about one minute to about 8 hours. However, the drying conditions may not be limited thereto. The collector may be any known collector material, for example, an aluminum film, a stainless film, a copper film, or a nickel film.

The electrode ink composition including the first solvent described above has a high contact angle with respect to the nozzle surface and the nozzle plate during ink-jet printing and a high contact angle with respect to the collector after ink-jet printing, and has a high drying rate. Due to these properties, the electrode ink composition is used to form an electrode having a fine pattern and a high resolution. Also, such an electrode having a fine pattern and a high resolution can be used to manufacture a thin micro secondary battery that is used as a power source for an integrated circuit device and a secondary battery having a three-dimensional electrode pattern.

A secondary battery according to another embodiment includes an electrode manufactured by ink-jet printing the electrode ink composition described above. The type of the secondary battery is not limited, and the secondary battery may be a stack type secondary battery. The secondary battery may be a primary lithium battery, a secondary lithium battery, or a fuel cell.

A method of manufacturing the secondary battery according to another embodiment has similarities to conventional methods except that an electrode manufactured by ink-jet printing the electrode ink composition is used. For example, a cathode composition according to another embodiment may be ink-jet printed on a predetermined collector and dried to form a cathode. Then, an anode composition according to another embodiment is ink-jet printed on the surface of the collector opposite to that on which the cathode is formed and then dried to form an anode. As a result, a bipolar electrode is manufactured.

An electrolytic layer having a predetermined thickness is formed on the cathode and/or anode on the bipolar electrode and then dried. Under an inert gas atmosphere, the bipolar electrode on which the electrolytic layer is formed is stacked to form a battery stack. An insulating sealing layer is formed on the battery stack and the resulting structure is packaged, thereby completing the manufacture of a secondary battery.

Hereinafter, aspects of the present invention will now be described in more detail with reference to the examples below, but the present invention is not limited thereto.

### Example

### Example 1

5 parts by weight of diethylene glycol (DEG) were added to a mixed solvent that includes 70 parts by weight of dimethyl acetamide (DMAC) and 20 parts by weight of ethanol (EtOH), and then 4.65 parts by weight of LiCoO₂, 0.15 parts by weight of acetylene black (AB), and 0.2 parts by weight of PVdF were added thereto. The mixture was dispersed by a paint shaker for 2 hours using zirconium beads having a particle size of 0.3 mm, and then was sequentially passed through a 1 μm poly(tetrafluoroethylene) (PTFE) syringe filter and a 0.45 μm PTFE syringe filter, thereby completing the manufacture of an electrode ink composition.

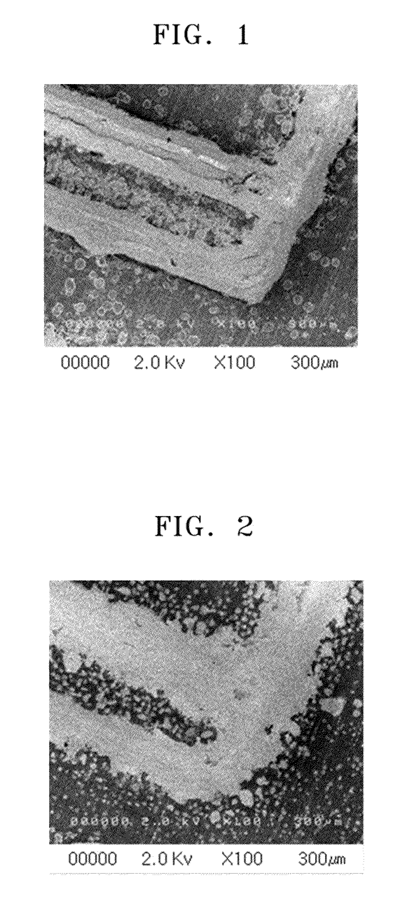

The electrode ink composition was printed on aluminum foil by using an ink-jet printer (Fuji Dimatix DMP-2800) to form a particular pattern. The ink-jet ejection result is shown in FIG. 1. The degree of pattern accuracy was evaluated with the naked eye. The results are shown in Table 3. Also, the contact angle between the electrode ink composition and the aluminum foil was measured with an evaluator (Krüss DSA-100). The results are shown in Table 3.

### Example 2

4.65 parts by weight of LiCoO₂, 0.15 parts by weight of acetylene black (AB), and 0.2 parts by weight of PVdF were added to a mixed solvent that included 90 parts by weight of dimethyl acetamide (DMAC) and 5 parts by weight of diethylene glycol (DEG). The mixture was dispersed by a paint shaker for 2 hours using zirconium beads having a particle size of 0.3 mm, and then was sequentially passed through a 1 μm PTFE syringe filter and a 0.45 μm PTFE syringe filter, thereby completing the manufacture of an electrode ink composition.

The electrode ink composition was printed on aluminum foil by using an ink-jet printer (Fuji Dimatix DMP-2800) to form a particular pattern. The degree of pattern accuracy was evaluated with the naked eye. The results are shown in Table 3. Also, the contact angle between the electrode ink composition and the aluminum foil was measured with an evaluator (DSA-100). The results are shown in Table 3.

### Example 3

4.65 parts by weight of LiCoO₂, 0.15 parts by weight of acetylene black (AB), and 0.2 parts by weight of PVdF were added to 95 parts by weight of dimethyl acetamide (DMAC). The mixture was dispersed by a paint shaker for 2 hours using zirconium beads having a particle size of 0.3 mm, and then was sequentially passed through a 1 μm PTFE syringe filter and a 0.45 μm PTFE syringe filter, thereby completing the manufacture of an electrode ink composition.

The electrode ink composition was printed on an aluminum foil by using an ink-jet printer (Fuji Dimatix DMP-2800) to form a particular pattern. The degree of pattern accuracy was evaluated with the naked eye. The results are shown in Table 3. Also, the contact angle between the electrode ink composition and the aluminum foil was measured with an evaluator (DSA-100). The results are shown in Table 3.

### Examples 4 to 6

Electrode ink compositions were respectively prepared in the same manner as in Examples 1 to 3, except that dimethyl formamide (DMF) was used in an amount shown in Table 1 below instead of dimethyl acetamide, electrodes were manufactured by using the electrode ink compositions, and the electrodes were evaluated. The results are shown in Table 3.

### Comparative Examples 1 to 3

Electrode ink compositions were respectively prepared in the same manner as in Examples 1 to 3, except that N-methylpyrrolidone (NMP) was used in the amount shown in Table 1 instead of dimethyl acetamide, electrodes were manufactured by using the electrode ink compositions, and the electrodes were evaluated. The results are shown in Table 3.

FIG. 2 is a photographic image showing the result produced when the electrode ink composition prepared according to Comparative Example 1 were prepared by ink-jet printing.

Meanwhile, the boiling point and surface tension of the solvents used in Examples 1-6 and Comparative Examples 1-3 are shown in Table 2 below.

TABLE 1

| | | | | | | | Comparative | Comparative | Comparative |
|---|---|---|---|---|---|---|---|---|---|
| | Example 1 | Example 2 | Example 3 | Example 4 | Example 5 | Example 6 | Example 1 | Example 2 | Example 3 |
| DMAC | 70 | 90 | 95 | — | — | — | — | — | — |
| DMF | — | — | | 70 | 90 | 95 | — | — | — |
| NMP | — | — | | — | — | — | 70 | 90 | 95 |
| EtOH | 20 | — | — | 20 | — | — | 20 | — | — |
| Moisturizing | 5 | 5 | — | 5 | 5 | — | 5 | 5 | — |
| agent | | | | | | | | | |
| (DEG) | | | | | | | | | |
| Active | 4.65 | 4.65 | 4.65 | 4.65 | 4.65 | 4.65 | 4.65 | 4.65 | 4.65 |
| material | | | | | | | | | |
| (LiCoO₂) | | | | | | | | | |
| Conductive | 0.15 | 0.15 | 0.15 | 0.15 | 0.15 | 0.15 | 0.15 | 0.15 | 0.15 |
| agent | | | | | | | | | |
| (AB) | | | | | | | | | |
| Binder | 0.2 | 0.2 | 0.2 | 0.2 | 0.2 | 0.2 | 0.2 | 0.2 | 0.2 |
| (PVdF) | | | | | | | | | |
| Viscosity | 3.96 | 4.12 | 4.21 | 3.89 | 4.09 | 4.08 | 4.25 | 4.65 | 4.66 |
| (mPa · sec at | | | | | | | | | |
| 1000 s⁻¹) | | | | | | | | | |

TABLE 2

| | NMP | DMF | DMAC |
|---|---|---|---|
| boiling point (1 atm) | 202° C. | 153~155° C. | 164~166° C. |
| Surface Tension | 40.79 dyne/cm | 36.76 dyne/ | 36.7 dyne/ |
| | | cm @ 20° C. | cm @ 20° C. |
| | | 36.42 dyne/ | 32.43 dyne/ |
| | | cm @ 25° C. | cm @ 25° C. |

TABLE 3

| | | | | | | | Comparative | Comparative | Comparative |
|---|---|---|---|---|---|---|---|---|---|
| | Example 1 | Example 2 | Example 3 | Example 4 | Example 5 | Example 6 | Example 1 | Example 2 | Example 3 |
| Contact | 20.8 | 20.2 | 21.3 | 18.5 | 19.1 | 19.0 | 12.2 | 11.9 | 12.5 |
| angle | | | | | | | | | |
| Pattern | ∘, | ∘ | ∘ | | | | x | x | x |
| accuracy | (see FIG. 1) | | | | | | (see FIG. 2) | | |

∘: good,
: moderate,
x: bad

Referring to Table 3, and FIGS. 1 and 2, it can be seen that an electrode having a high contact angle and high pattern accuracy can be manufactured by ink-jet printing an electrode ink composition according to these embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode ink composition for ink-jet printing, comprising:
an electrode active material, and
a solvent, wherein
the solvent further comprises a first solvent having a boiling point in a range of about 150 to about 170° C. at 1 atm, and a surface tension of 30 dyne/cm or more at 25° C.

2. The electrode ink composition of claim 1, wherein the first solvent is a solvent comprising an amide group.

3. The electrode ink composition of claim 2, wherein the first solvent comprising the amide group is selected from the group consisting of dimethyl acetamide, dimethyl formamide, and a mixture of these.

4. The electrode ink composition of claim 1, wherein the amount of the first solvent is in a range of about 80 to about 100 weight % based on the total weight of the solvent.

5. The electrode ink composition of claim 1, wherein the amount of the electrode active material is in a range of about 1 to about 20 weight % based on the total weight of the electrode ink composition.

6. The electrode ink composition of claim 1, wherein the viscosity of the electrode ink composition is 100 mPa·sec or less when measured at a temperature of 25° C. and a shear rate of 1000 s−1.

7. The electrode ink composition of claim 6, wherein the viscosity of the electrode ink composition is 0.5 to 5 mPa·sec when measured at a temperature of 25° C. and a shear rate of 1000 s−1.

8. The electrode ink composition of claim 1, wherein the solvent further comprises a second solvent selected from the group consisting of saturated hydrocarbons, aromatic hydrocarbons, alcohols, ketones, esters, ethers, dimethylsulfoxide, and mixtures thereof.

9. The electrode ink composition of claim 1, further comprising at least one component selected from the group consisting of a binder, a conductive agent, a moisturizing agent, a dispersant, and a buffer.

10. A secondary battery electrode manufactured by ink-jet printing an electrode ink composition comprising:
an electrode active material; and
a solvent, wherein the solvent further comprises a first solvent having a boiling point in a range of about 150 to about 170° C. at 1 atm, and a surface tension of 30 dyne/cm or more at 25° C.

11. A secondary battery comprising the secondary battery electrode of claim 10.

12. The secondary battery electrode of claim 10, wherein the first solvent is a solvent further comprising an amide group.

13. The secondary battery electrode of claim 12, wherein the first solvent comprising the amide group is selected from the group consisting of dimethyl acetamide, dimethyl formamide, and a mixture of these.

14. The secondary battery electrode of claim 10, wherein, the amount of the first solvent is in a range of about 80 to about 100 weight % based on the total weight of the solvent.

15. The secondary battery electrode of claim 10, wherein the amount of the electrode active material is in a range of about 1 to about 20 weight % based on the total weight of the electrode ink composition.

16. The secondary battery electrode of claim 10, wherein the viscosity of the electrode ink composition is 100 mPa·sec or less when measured at a temperature of 25° C. and a shear rate of 1000 s−1.

17. The secondary battery electrode of claim 16, wherein the viscosity of the electrode ink composition is 100 mPa·sec or less when measured at a temperature of 25° C. and a shear rate of 1000 s−1.

18. The secondary battery electrode of claim 10, wherein the solvent further comprises a second solvent selected from the group consisting of saturated hydrocarbons, aromatic hydrocarbons, alcohols, ketones, esters, ethers, dimethylsulfoxide, and mixtures thereof.

19. The electrode ink composition of claim 1, wherein the electrode active material comprises a lithium-transition metal oxide.

20. The electrode ink composition of claim 19, wherein the lithium-transition metal oxide is selected from the group consisting of lithium-cobalt, lithium-nickel, lithium-manganese, lithium-chromium, lithium-iron, lithium-vanadium, lithium-titanium, and combinations thereof.
